(19) United States
(12) Patent Application Publication
(10) Pub. No.: US 2016/0335042 A1
(43) Pub. Date: Nov. 17, 2016

(54) SYSTEM FOR CONTROL OF ONE OR MORE MIDI DEVICES

(71) Applicant: MUZELOUNGE INC., STITTSVILLE (CA)

(72) Inventors: SANJAY BELKHODE, OTTAWA (CA); JOSEPH LEON RENE RICHARD, KAPUSKASING (CA)

(21) Appl. No.: 15/155,360

(22) Filed: May 16, 2016

Related U.S. Application Data
(60) Provisional application No. 62/161,573, filed on May 14, 2015.

(51) Int. Cl. G06F 3/16; H04L 29/08; G06F 3/0484

(52) U.S. Cl. CPC G06F 3/162; G06F 3/04847; G06F 3/04842; H04L 67/02; H04L 67/06

(57) ABSTRACT

Whilst the Musical Instrument Digital Interface (MIDI) revolutionized an industry and brought it into the digital era it also has limitations arising from its definition and establishment whilst the digital era was in its infancy. In the intervening 30 years whilst the MIDI specification has evolved to reflect changes in underlying technology etc. the user experience has remained fairly constant and difficult with each vendor offering different MIDI interfaces for the user to learn and employ. It would be beneficial therefore to address limitations within the existing solutions exploiting MIDI standards allowing users to control MIDI devices simultaneously, save settings for subsequent use, and provide users with a cloud based distribution and access network to MIDI settings as have become popular and well established in many areas of human activity including music.

### FIELD OF THE INVENTION

This invention relates to MIDI-enabled devices and more particularly to a simplified software-based user interface and software application for improved control of MIDI devices and a cloud-based server for the management and sharing of MIDI patches.

### BACKGROUND OF THE INVENTION

In the last 30 years digital electronics has penetrated nearly every aspect of human endeavor and today consumers carry portable electronic devices with wireless interfaces, Internet connectivity, digital cameras, high resolution displays, microphones, global positioning, environmental sensors, and the capability to run a wide range of software applications from social media and social networks through content consumption and generation to remotely controlling drones, security systems, and any web enabled device whose Internet Protocol (IP) address is known to them or their software applications.

In most areas of digital electronics, communications and media this requires vendors to employ nationally or internationally agreed standards. For example, a telecommunications service provider offering customers the ability to remotely control a digital set-top box (STB) or personal video recorder (PVR) does not want different customers using different software applications etc. depending upon the manufacturers of the devices they provide nor as a manufacturer obsoletes and replaces devices.

One such standard is the Musical Instrument Digital Interface (MIDI) established in the early 1980s as the technical standard defining a protocol, digital interface and connectors allowing a wide variety of electronic musical instruments, computers and other related electronic devices to connect and communicate with one another. Originally targeted at who wanted to use electronic instruments in the production of popular music it also spurred a rapid expansion of the sales and production of electronic instruments and music software. Coinciding with the evolution of the personal computer and the Internet MIDI has to date transformed the way musicians work as well as allowing users with no musical notation skills to build complex arrangements as well as store, edit, and replay audio content.

However, whilst MIDI has revolutionized an industry and brought it into the digital era it also has limitations arising from its definition and establishment whilst the digital era was in its infancy. Accordingly, it would be beneficial to address limitations within the existing solutions exploiting MIDI standards allowing users to control MIDI devices simultaneously, save settings for subsequent use, and provide users with a cloud based distribution and access network to MIDI settings as have become popular and well established in many areas of human activity including music.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to MIDI-enabled devices and more particularly to a simplified software-based user interface and software application for improved control of MIDI devices and a cloud-based server for the management and sharing of MIDI patches.

In accordance with an embodiment of the invention there is provided a method comprising:
providing an electronic device comprising at least a microprocessor and a haptic interface;
providing to the user a graphical user interface relating to a MIDI controller application;
establishing within the graphical user interface a plurality of controls, each control associated with a predetermined MIDI device of a plurality of MIDI devices; and providing the user with options relating to the plurality of controls, wherein
   a first option comprises:
   establishing for each control within the plurality of controls a control setting via the haptic interface;
   associating the plurality of controls and their control settings with a patch; and
   storing the patch in association with an identity of the patch for subsequent retrieval and use within a memory;
      a second option comprises:
   associating a predetermined subset of the plurality of controls into a group via the haptic interface;
   establishing for the group relationships between the predetermined subset of the plurality of controls and a group control via the haptic interface; wherein
   adjusting the group control results in all of the predetermined subset of the plurality of controls associated with the group to which the group control relates being adjusted in dependence upon the adjustment made by the user to the group control and the relationship of each control of the predetermined subset of the plurality of controls to the group control; and
      a third option comprises:
   establishing for each control within the plurality of controls a control setting via the haptic interface;
   controlling the plurality of MIDI devices in dependence upon the control settings of the plurality of controls.

In accordance with an embodiment of the invention there are provided computer executable instructions stored within a non-volatile non-transitory memory, the instructions when executed relating to a process comprising:
providing an electronic device comprising at least a microprocessor and a haptic interface;
providing to the user a graphical user interface relating to a MIDI controller application;
establishing within the graphical user interface a plurality of controls, each control associated with a predetermined MIDI device of a plurality of MIDI devices; and
providing the user with options relating to the plurality of controls, wherein
   a first option comprises:
   establishing for each control within the plurality of controls a control setting via the haptic interface;
   associating the plurality of controls and their control settings with a patch; and
   storing the patch in association with an identity of the patch for subsequent retrieval and use within a memory;
      a second option comprises:
   associating a predetermined subset of the plurality of controls into a group via the haptic interface;
   establishing for the group relationships between the predetermined subset of the plurality of controls and a group control via the haptic interface; wherein
   adjusting the group control results in all of the predetermined subset of the plurality of controls associated with the group to which the group control relates being adjusted in dependence upon the adjustment made by the user to the group control and the relationship of each control of the predetermined subset of the plurality of controls to the group control; and
      a third option comprises:
   establishing for each control within the plurality of controls a control setting via the haptic interface;
   controlling the plurality of MIDI devices in dependence upon the control settings of the plurality of controls.

In accordance with an embodiment of the invention there is provided a method comprising providing to a user via a graphical user interface on an electronic device access to an online portal, providing to the user within the graphical user interface with options relating to a patch associated with a software application controlling a plurality of MIDI devices, and determining an action in dependence upon the option selected by the user.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts a prior art control embodiment of devices through MIDI;

FIG. 1B depicts schematically the flow from an instrument's original sound to the resultant sound as heard by a listener according to an embodiment of the invention;

FIG. 1C depicts an electronic device supporting communications to a network and therein remote servers, MIDI devices, etc. and supporting software applications according to embodiments of the invention;

FIG. 2 depicts an application interface according to an embodiment of the invention providing control of discrete and multiple MIDI devices simultaneously;

FIG. 3 depicts an exemplary MIDI controller application ecosystem as supported by embodiments of the invention;

FIG. 4 depicts an exemplary foundational and variable patch hierarchy within an exemplary MIDI controller application according to an embodiment of the invention;

FIG. 5 is an exemplary MIDI controller application ecosystem as supported by embodiments of the invention for devices and patches exploiting cloud infrastructure;

FIG. 6 is a flowchart for the addition of a new MIDI device to an exemplary MIDI controller application according to an embodiment of the invention;

FIG. 7 is an example of a sound effect characterization module within an exemplary MIDI controller application according to an embodiment of the invention; and

FIG. 8 is an example of a sound effect characterization module using sound snips within an exemplary MIDI controller application according to an embodiment of the invention.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

The present invention is directed to MIDI-enabled devices and more particularly to a simplified software-based user interface and software application for improved control of MIDI devices and a cloud-based server for the management and sharing of MIDI patches.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users. Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, and smart glasses.

A “server” as used herein, and throughout this disclosure, refers to one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of community organizations, members of charity organizations, men, women, and children. In its broadest sense the user may further include, but not be limited to, software systems, mechanical systems, robotic systems, android systems, etc. that may be characterised by an ability to exploit one or more embodiments of the invention. A user may also be associated through one or more accounts and/or profiles with one or more of a service provider, third party provider, enterprise, social network, social media etc. via a dashboard, web service, website, software plug-in, software application, and graphical user interface.

“User information” as used herein may refer to, but is not limited to, user behavior information, user preferences, user personal data, and user profile information.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “Musical Instrument Digital Interface” (MIDI) as used herein may refer to, but is not limited to, a standard protocol, interface, connection, control protocol and/or command instructions that allow electronic musical instruments and electronic musical devices to communicate with each other. MIDI may therefore include the MIDI Standard as managed by the MIDI Manufacturers Association but may also include other standards including public domain standards, open source standards, and proprietary standards.

A “MIDI instrument” (or instrument) as used herein may refer to, but is not limited to, an electronic musical instrument, electronically augmented musical instrument and/or sound-generating device that is MIDI enabled and produces an original sound. A MIDI instrument may include, but not be limited to, a physical instrument, a computer-based “virtual” instrument, a sound generating device, a sound processing device, a graphical user interface or software application simulating a musical instrument and/or musical device.

A “MIDI device” as used herein may refer to, but is not limited to, a device that is MIDI enabled with a plurality of controls that are coupled with another device including, but not limited to, one or more other MIDI instruments, one or more other MIDI devices, non-MIDI-enabled devices and a graphical user interface or software application simulating a musical instrument and/or musical device. A MIDI device may modify both original and MIDI modified sounds produced by a MIDI instrument and/or other MIDI device.

A “control” as used herein may refer to, but is not limited to, a setting, parameter, variable which relates to one or more parameters which define and/or affect and/or effect the audio signal received by a MIDI device and generate therefrom a modified output audio signal. A control may be implemented and established/varied/set by a user through a graphical user interface within a software application or it may be established through one or more haptic interfaces, vocal commands, text commands, visual commands, motion, orientation, etc.

A “sound” as used herein may refer to, but is not limited to, music, vocals, computer generated sounds, ambient noise, and any audio signal acquired and/or generated. A sound may be digital and/or analog in nature as acquired and/or processed.

An “original sound” as used herein may refer to, but is not limited to, a sound directly produced by a source of sound, e.g. a musical instrument, a singer, etc. An original sound may therefore be an input audio signal or a predetermined portion of an input audio signal, e.g. a track within a multi-track input, to a MIDI device.

A “modified sound” as used herein may refer to, but is not limited to, an original sound as modified by a MIDI device, and therefore may be the output audio signal or a predetermined portion of an output audio signal, e.g. a track within a multi-track input, from a MIDI device.

“Resultant sound” as used herein may refer to, but is not limited to, a final sound or final audio heard by a listener or listeners.

A “patch” as used herein may refer to, but is not limited to, a specific configuration of a portion of the controls of typically one MIDI device, but it could be two or more MIDI devices.

A “combined patch” as used herein may refer to, but is not limited to, a combination of patches wherein each patch within the combined patch relates to a portion of the overall group of coupled MIDI devices controlled through the combined patch. Accordingly, a combined patch may include patches that are combined with respect to a MIDI device and/or MIDI instrument as well as patches that are not overlapping in respect of any MIDI device and/or MIDI instrument controlled.

A “haptic interface” as used herein may refer to, but is not limited to, an interface and/or system that allows a user to interact with an electronic device, e.g. PED and/or FED, through bodily sensations and/or movements. A haptic interface provides tactile feedback or other bodily sensations indicating the users action with respect to the interface in order to start, stop, control, adjust, or perform an action or actions and/or process or processes upon a local and/or remote electronic device. A haptic interface may include, but is not limited to, a keypad, a keyboard, a pointer, a mouse, a touchpad, a touchscreen, a pedal, a haptic glove, and a stylus.

A “sound snippet” or “sound snip” as used herein may refer to, but is not limited to, a small part of an item of audio content, a sample of an item of audio content, or a complete short duration item of audio content. Such items of audio content may include, but not be limited to, a piece of music, a conversation, a note from an instrument, a sound effect, a song, a digitally created audio element, and ambient noise.

Manufacturers in the music industry have developed electronic instruments such as keyboard-based synthesizers for use by musicians. Such devices permit a greater dynamic range of sounds available to the musicians. Equally, there are electronic devices available to the musician which can either create or modify sounds. A majority of these devices and instruments are MIDI-enabled. MIDI-enabled instruments such as keyboard synthesizers permit musicians to create a vast number of unique sounds for their musical compositions. Equally, it is true for MIDI-enabled devices with the added capability of modifying the sound of an original sound of a guitar or other instrument.

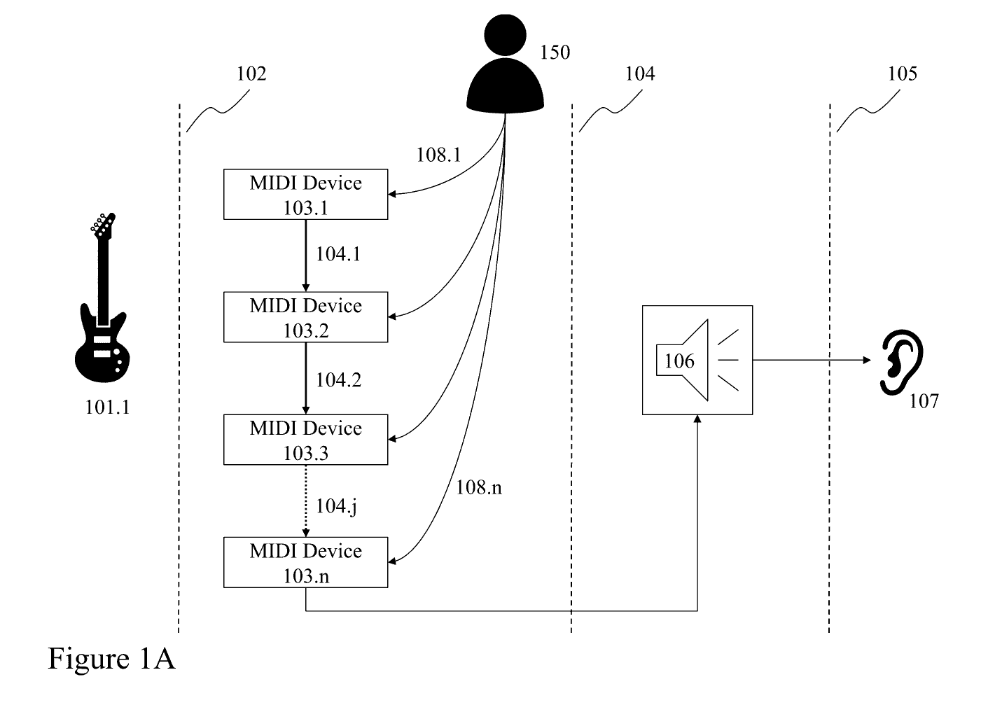

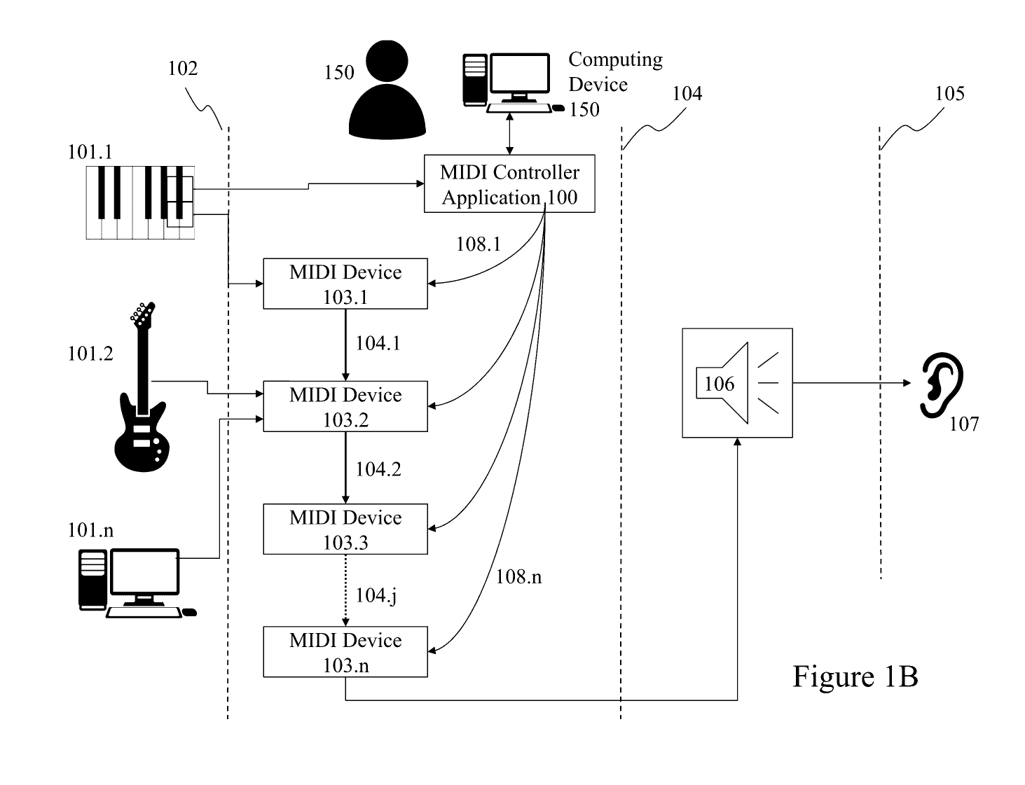

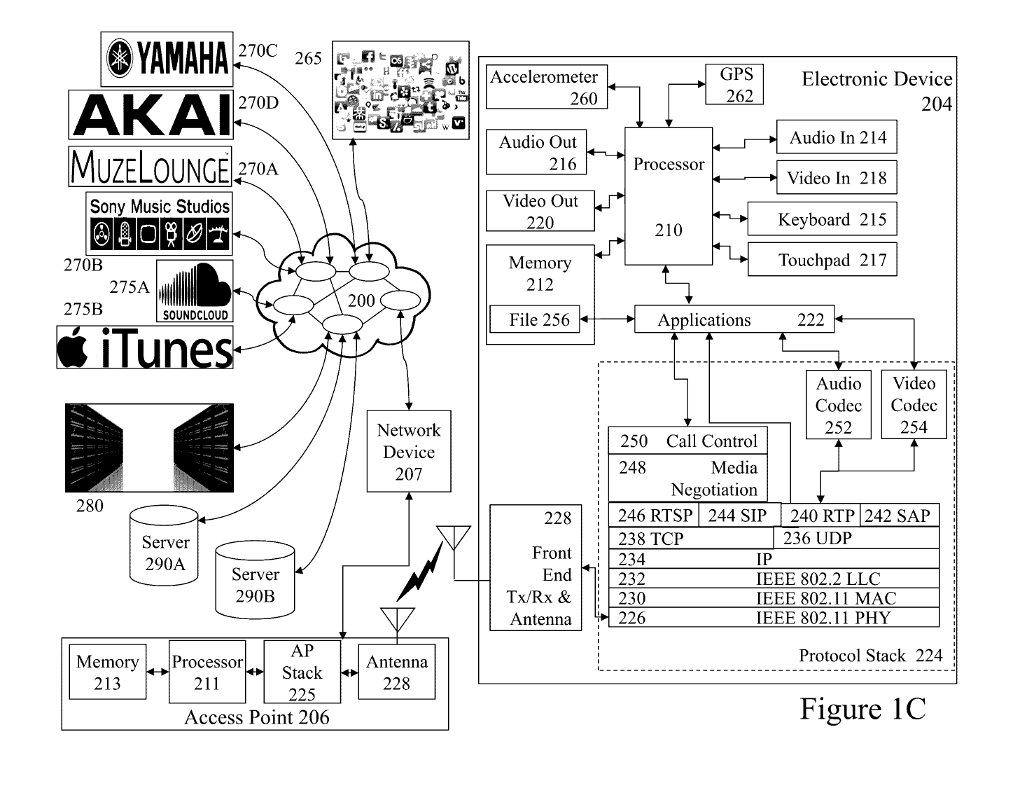

Referring to FIG. 1A there is depicted a prior art control embodiment of devices through a MIDI system. Accordingly, each MIDI device 103.1 to 103.n, coupled to an instrument 101.1 which contains a plurality of controls. Each MIDI device 103.1 to 103.n has its own graphical user interface on the instrument 101.1, generally comprising a plurality of hardware buttons of different forms, and a means to save a customized set of controls into a patch. Within the prior art MIDI systems, each MIDI device 103.1 to 103.n is programmed and managed independently.

The user 150 manually adjusts each of the plurality of controls of each MIDI device 103.1 to 103.n to create control configurations. Accordingly, an original sound 102 generated by instrument 101.1 is modified by a first control configuration with respect to first MIDI device 103.1 wherein it becomes a modified sound 104.1. Modification of the sound continues through each control configuration of each subsequent MIDI device 103.2 to 103.n to create the modified sounds 104.2 to 104.n. The final modified sound 104.n then passes through an output device 106, e.g. a loudspeaker. to become a resultant sound 105 as heard by the listener 107.

A problem with existing MIDI systems is that a user often operates with multiple MIDI devices, with each MIDI device having a completely different interface, and up to thousands of different controls per MIDI device. The control panels of existing MIDI devices are typically very difficult to use. There is also a need for a cloud content sharing community and storage library allowing MIDI users to save, manage, backup, upload and share their patches with other users. The storage library can optionally reside on a user's local electronic device. There is a further need for a librarian function in the storage library, to manage the plurality of patches and/or combined patches, and including capabilities to send and receive patches based on the target MIDI device's capability. Accordingly, the inventors have established according to embodiments of the invention software systems and/or applications providing these desired functions and connectivity, social interactions, marketplace etc.

Now referring to FIG. 1B there is depicted schematically the flow from an instrument's original sound to the resultant sound as heard by a listener according to an embodiment of the invention. Accordingly, as depicted a user 150 employs an electronic device, e.g. a PED or FED, upon which a MIDASP 100, e.g. a MIDI Controller Application, is in execution allowing the user 150 to manage all the controls of all the MIDI devices 103.1 to 103.n in a consistent and user-friendly manner as the MIDASP 100 provides a consistent user interface and control interfaces. Accordingly, one or more instruments 101.1 to 101.n each produce an original sound 102. A user 150 couples one or more MIDI devices 103.1 to 103.n to the MIDASP 100. This coupling may be through, for example, a wired interconnection, a wireless interconnection or a network interconnection through a local area network, local wireless network, or global network such as the Internet by exploiting Internet Protocol (IP) addresses of the MIDI devices 103.1 to 103.n which are either known to the user or may be discovered using one or more techniques as known in the art.

From the MIDASP 100, the user 150 configures the plurality of controls of each coupled MIDI device 103.1 to 103.n, via the MIDASP 100 installed on the 140, to create a patch 108 for each MIDI device 103.1 to 103.n, or a combined patch 109 of all MIDI devices 103.1 to 103.n. With one or more patches 108.1 to 108.n or a combined patch 109 applied to the MIDI devices 103.1 to 103.n via the MIDASP 100, each original sound passes to the appropriate first MIDI device and thereafter through the remainder of the MIDI devices 103.1 to 103.n to become a modified sound 104. The modified sound passes through an output device 106, such as a loudspeaker or amplifier and loudspeaker, to create the resultant sound 105 as heard by the listener 107. Accordingly, as depicted a keyboard (instrument 101.1) is coupled to MIDI device 103.1 and thereafter through MIDI devices 103.2 to 103.N whilst a guitar (instrument 101.2) is coupled to MIDI device 103.2 and thereafter through MIDI devices 103.3 to 103.N. As depicted an instrument may include another electronic device 101.n, e.g. a PED or FED.

With the software integration of one or more MIDI devices 103.1 to 103.n in the MIDI system, via MIDASP 100, e.g. a MIDI Controller Application, a customized combination of controls on a portion of the MIDI devices are saved as a patch. These may be employed, stored, distributed, retrieved, and executed discretely or in combination with other patches and/or combined patches. A combination of patches can be made to provide a combined patch, which may similarly be employed, stored, distributed, retrieved, and executed discretely or in combination with other patches and/or combined patches.

Accordingly, as depicted the user 150 may establish patches 108.1 to 108.n in respect of MIDI devices 103.1 to 103.n which are backed up, employed stored, retrieved, managed and executed discretely. Alternatively, they may combine these patches 108.1 to 108.n to combo-path 109 and similarly this may be backed up, employed stored, retrieved, managed and executed discretely. Accessing combined patch 109 provides the user with all patches 108.1 to 108.n without requiring the user to source and identify each. In this manner the user 150 may employ an externally acquired patch 108.1 in combination with patches 108.2 to 108.n.

Accordingly, the MIDASP 100 allows the user to adjust the multiple MIDI device controls to create the desired sound by selecting a saved patch or combined patch from memory. Equally, they may create a new desired sound and save this for subsequent use. The MIDASP 100 displays the multiple controls of each MIDI device in a consistent manner which increases the usability for the user who must otherwise work with multiple controls, potentially within multiple graphical user interfaces. A combined patch may store and present a user customized viewing of the particular user's favorite controls from each MIDI device 108.1 to 108.n. Accordingly, a second combined patch (not depicted for clarity) employing patch 108.1 automatically establishes the user customized view of the user's favorite controls from each MIDI device 108.1 and unless modified does not generate and/or store a new patch. Alternatively, if the user changes patch 108.1 they may elect to have this stored and over-write the original patch such that all subsequent uses now reflect their new preference. Accordingly, combined patches may store associations of patches such that for example, two combined patches, may employ 5 patches of which 4 are common in each combined patch whereas whilst the fifth patch in each combo-path relates to the same MIDI device the patches are different due to the particular sound, effect, result that the user is seeking to establish. Tabs within the MIDASP 100 may allow the user to seamlessly switch between the controls/patch for each MIDI device or alternatively each tab may relate to a different subset of the controls for the MIDI devices and all MIDI devices are depicted on the tab wherein their controls were selected to be within the patch by the user or a third party when the user acquires the patch from the third party.

Now referring to FIG. 1C there is depicted an Electronic Device 204 supporting communications to a network and therein remote servers, MIDI devices, etc. and supporting software applications according to embodiments of the invention such as MIDASP 100. Accordingly, the Electronic Device 204 is connected to Network 200 which is then coupled to a Remote Central Exchange 280 which communicates with the remainder of a telecommunication service providers network via Network 200 and/or other networks which may include for example long-haul OC-48/OC-192 backbone elements, an OC-48 wide area network (WAN), a Passive Optical Network, and a Wireless Link. The Remote Central Exchange 280 is connected via Network 200 and/or other networks to local, regional, and international exchanges (not shown for clarity). Electronic Device 204 is connected to Network 200 via Access Point 206 and Network Device 207. The wireless communications between Electronic Device 204 and Access Point 206 may be through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.10, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 and Bluetooth as well in an ad-hoc manner.

Access Point 206 is depicted as connected to Network Device 207 and therein Network 200 via a wired interface which may be through one or more wired communications standards such as, including, but not limited to, DSL, Dial-Up, DOCSIS, Ethernet, G.hn, ISDN, MoCA, PON, and Power line communication (PLC) which may or may not be routed through a router (not shown for clarity).

Also connected to the Network 200 are Social Networks (SOCNETS) 265, first and second software providers 270A and 270B respectively, e.g. MuzeLounge™ and Sony Music™, first and second electronic instrument manufacturers 270C and 270D, e.g. Yamaha™ and Akai™, and first to second online service providers 275A and 275B respectively, e.g. SoundCloud™ and Apple™ iTunes™, as well as first and second servers 290A and 290B which together with others, not shown for clarity. First and second servers 290A and 290B may host according to embodiments of the inventions multiple services associated with a provider of MIDI software, a provider of MIDI Device Applications, Software, and/or Platforms (MIDASPs); a provider of a SOCNET or Social Media (SOME) exploiting MIDASP features; a provider of a SOCNET and/or SOME not exploiting MIDASP features; a provider of services to PEDS and/or FEDS; a provider of one or more aspects of wired and/or wireless communications; license databases; content databases; image databases; content libraries; customer databases; websites; and software applications for download to or access by FEDs and/or PEDs exploiting and/or hosting MIDASP features. First and second primary servers 290A and 290B may also host for example other Internet services such as a search engine, financial services, third party applications and other Internet based services.

Accordingly, a user may exploit Electronic Device 204 to access first and/or second primary servers 290A and 290B respectively to perform an operation such as accessing/downloading an application which provides MIDASP features according to embodiments of the invention; execute an application already installed providing MIDASP features; execute a web based application providing MIDASP features; or access content. Similarly, a user may undertake such actions or others exploiting embodiments of the invention exploiting a PED or FED within first and second user groups 100A and 100B respectively via one of first and second cellular APs 195A and 195B respectively and first Wi-Fi nodes 110A.

The Electronic Device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic Device 204 may include an audio input element 214, for example a microphone, and an audio output element 216, for example, a speaker, coupled to any of processors 210. Electronic Device 204 may include a video input element 218, for example, a video camera or camera, and a video output element 220, for example an LCD display, coupled to any of processors 210. Electronic Device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the Electronic Device 204. The one or more applications 222 that are typically stored in memory 212 and are executable by any combination of processors 210. Electronic Device 204 also includes accelerometer 260 providing three-dimensional motion input to the process 210 and GPS 262 which provides geographical location information to processor 210.

Electronic Device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 21, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the Electronic Device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by Electronic Device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.10, IMT-1000, DSL, Dial-Up, DOCSIS, Ethernet, G.hn, ISDN, MoCA, PON, and Power line communication (PLC).

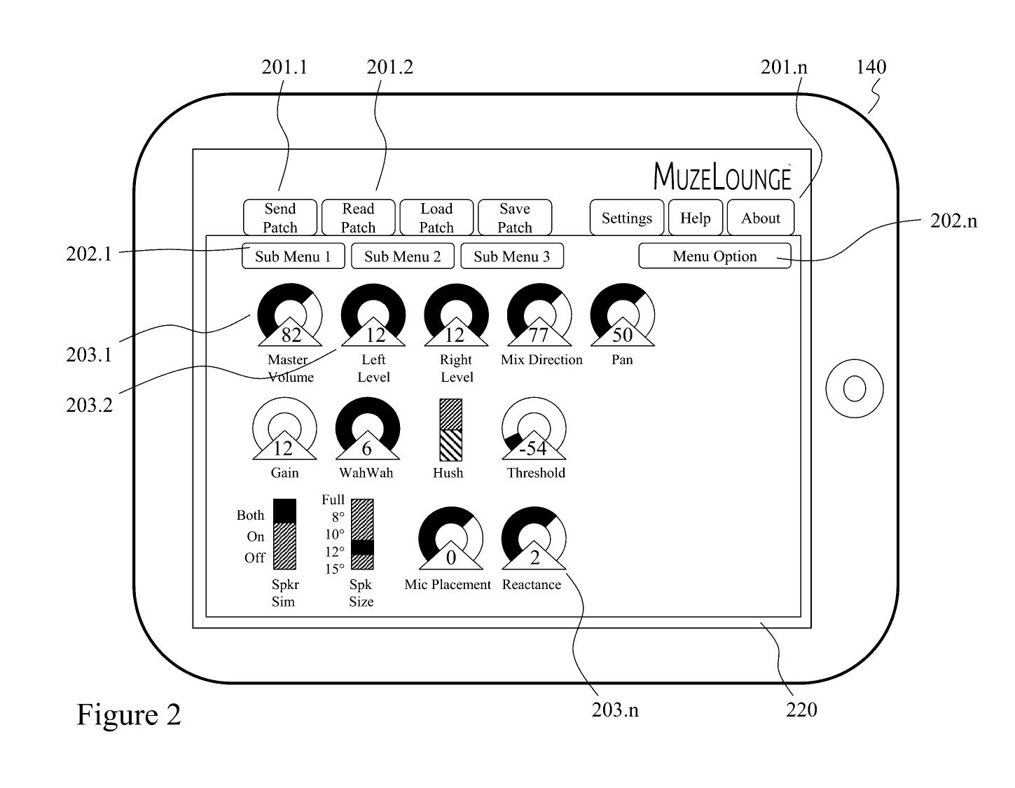

Now referring to FIG. 2 there is depicted an application interface according to an embodiment of the invention providing control of discrete and multiple MIDI devices simultaneously. Accordingly, the application interface/graphical user interface (GUI) 220 is provided as part of a software application in execution upon an Electronic Device 140, which is depicted as a tablet and hence a PED but it may also be a FED. The GUI 220 provided by the software application allows the user to control one or more MIDI devices and also provides a library (database) function for a plurality of patches, including foundational and variable sub-patches, patches, and combined patches such as described and discussed below in respect of embodiments of the invention. Within the library function the user is presented with capabilities including, but not limited to, renaming or sorting all patches in dependence upon one or more pre-assigned filters of a plurality of pre-assigned filters. The Electronic Device 140 is coupled to one or more MIDI devices 103.1 . . . 103.n, as depicted in FIG. 1B for example, via a wired interface or wireless interface. Using the GUI 220, for example through a touch screen of the Electronic Device 140, of the MIDASP 100 the user 150 can select a command or action from tabs 201.1 to 201.n, including sending a patch to a device or saving a patch in the application memory. Subtabs 202.1 to 202.n allow the user 150 to categorize MIDI control icons 203.1 to 203.n of connected devices based on user preferences or by MIDI device. The control icons 203.1 to 203.n displayed on the MIDASP 100 by the GUI 220 allowing the user 150 to adjust the specific MIDI controls of each coupled MIDI device to create a patch 108, or to adjust the controls of a set of coupled MIDI devices 103.1 . . . 103.n to create a combined patch 109.

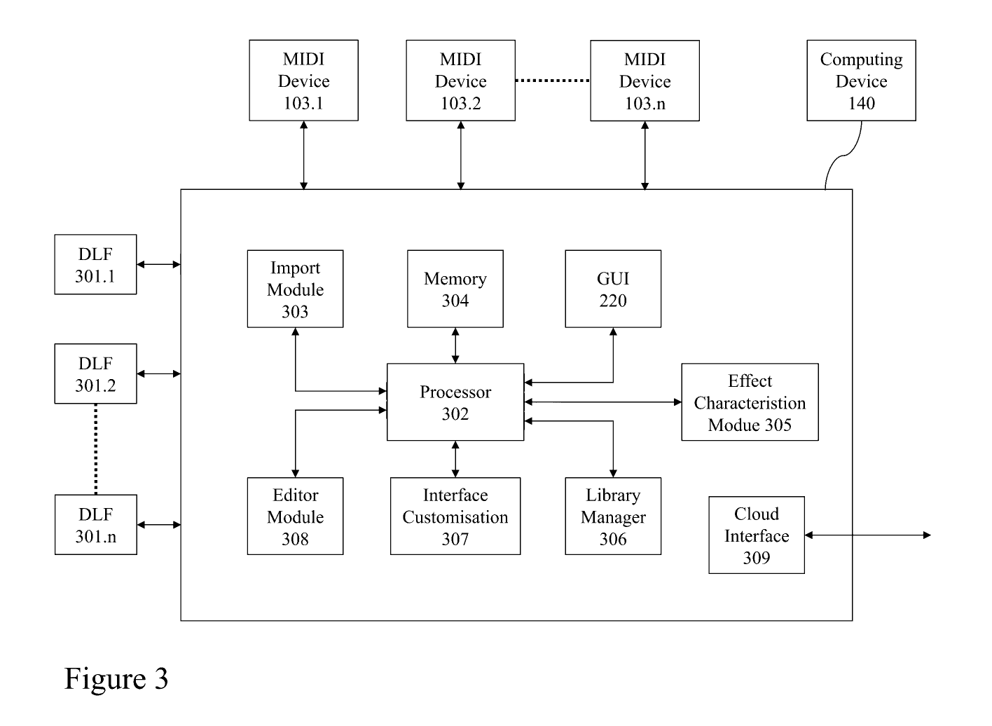

Referring to FIG. 3 there is depicted an exemplary MIDI controller application ecosystem as supported by embodiments of the invention. Accordingly, an Electronic Device 140 is coupled to one or more MIDI devices 103.1 . . . 103.n, and the MIDASP 100 installed and executed on the Electronic Device 140 presents a GUI 220 to the user having been retrieved from memory 304 and processed by a processor 302 or alternatively accessed through a web browser application on the Electronic Device 140. The MIDASP 100 may contain modules for different functions, including, but not limited to, an editor module 308, library manager 306, import module 303, interface customization 307, and effects characterization 305. When adding a new MIDI device 103.n to the MIDASP 100, one or more device library files (DLF) 301.1, 301.2 . . . 301.n, containing encrypted system-exclusive codes from the manufacturer, are acquired (e.g. purchased) and imported to the memory 304 of the Electronic Device 140. The MIDASP 100 updates the GUI 220 to include the new controls of a newly-added MIDI device 103.n.

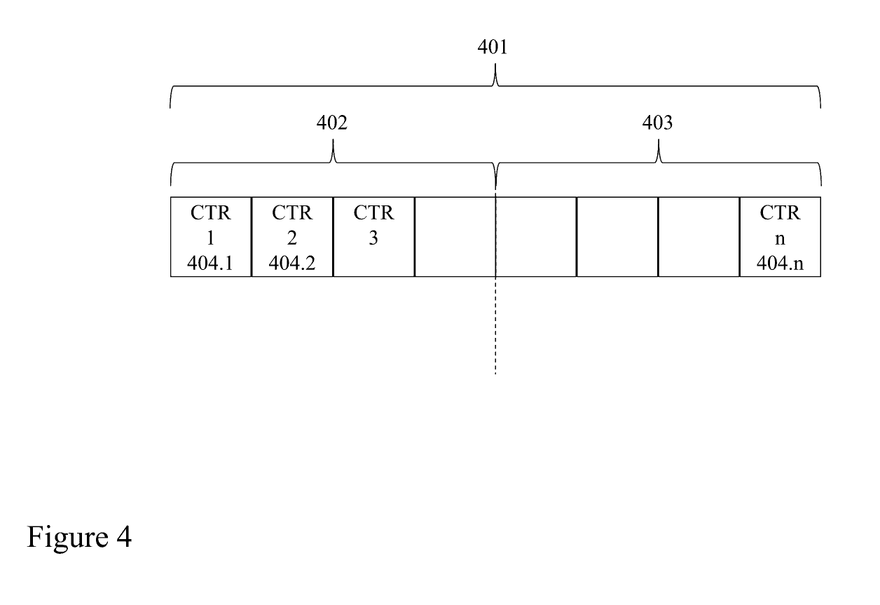

In a further embodiment, a patch can optionally be split into two or more sub-patches where one or more sub-patch is fixed (or foundational) and other sub-patches are variable. A patch can optionally comprise sub-patches organized in a hierarchical manner, such that changing one sub-patch in the hierarchy generates a new patch with a different modified sound. The user can then mix foundational and variable patches of different MIDI devices to create new patches with different modified sounds. Such a foundational and variable patch hierarchy is depicted in FIG. 4 wherein a configuration 401 of a plurality of controls 404.1 . . . 404.n form a patch, which can optionally be split into sub-patches. Foundational patch 402 can be combined with different variable patches, such as variable patch 403.

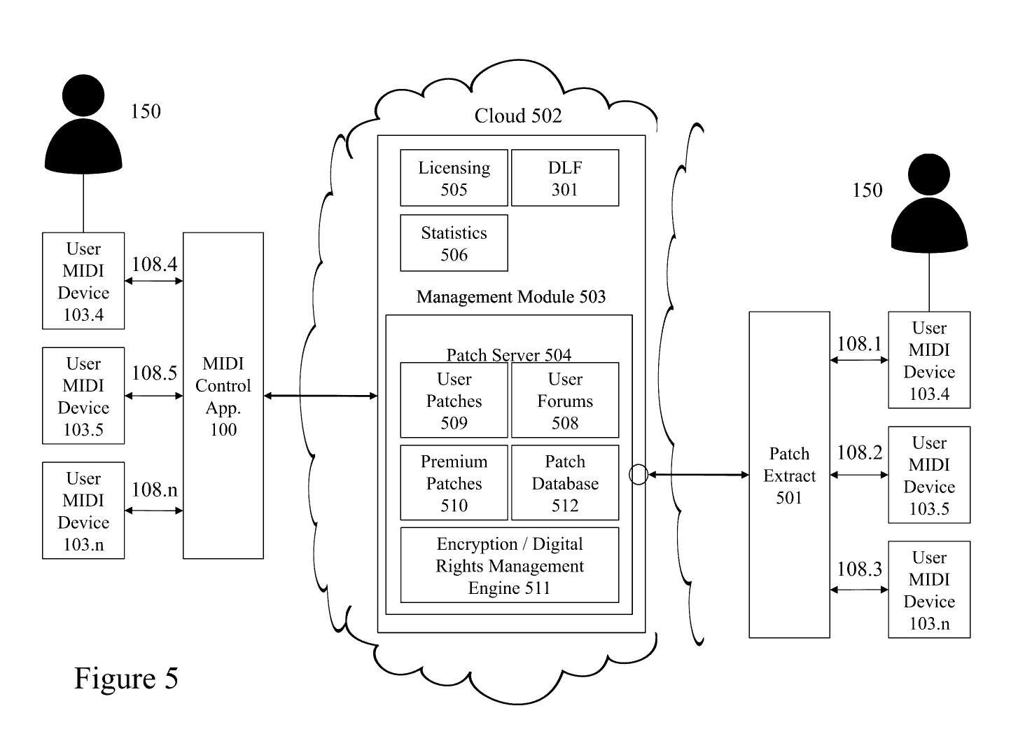

Now referring to FIG. 5 there is depicted an exemplary MIDI controller application ecosystem as supported by embodiments of the invention for devices and patches exploiting cloud infrastructure. As depicted users 150 each create MIDI patches 108.1 . . . 108.3 respectively for their MIDI devices 103.1 . . . 103.3 respectively. The patches 108.1 . . . 108.3 respectively are uploaded to the Cloud Server 502 via a patch extractor application 501 for users who do not have the MIDASP 100 installed. Optionally, a user 150 may upload patches 108.4 . . . 108.n for their MIDI devices 103.4 . . . 103.n to the Cloud Server 502 via the MIDASP 100. In the Cloud Server 502, a patch server 504 offers a user 150 the means to store their patches 108.1 . . . 108.n on the patch database 512, or share the patches 108.1 . . . 108.n in a library of user patches 509, with an option to sell their patches 108.1 . . . 108.n through the premium patch 510 section of the patch server 504. Users 150 can add patches 108.1 . . . 108.n of any MIDI device or instrument, and include a textual description of any shared patch 108.1 . . . 108.n. A patch server 504 within the Cloud Server 502 may also include an encryption and digital rights management engine 511 for the encryption of patches 108.1 . . . 108.n and for copy protection. Optionally, user forums 508 for users 150 allows them to discuss patches, music and all-things MIDI, and can include articles written by thought leaders in the music industry. Within the Cloud Server 502 there is also provided a management module 503, offering users statistics 506 of patch uploads, number of shares, and patch ratings and reviews, while users 150 who wish to license their patches 108.1 . . . 108.n may do so through license management 505 within the management module 503, where licenses may be sold to users 150.

Typically, users 150 would login to the patch server 504 with a unique identification and password either established by them upon registration or sent upon registration. Upon registration, users 150 may subscribe to any of the user forums 508, and subscribe to updates on MIDI-related matters. The management module 503 also may include search capabilities for patches 108.1 . . . 108.n based on manufacturer, year, model, or version, and advanced search parameters. The librarian manager module 306 included in the MIDASP 100 can be designed to efficiently manage the sub-patches and the creation of patches from sub-patches.

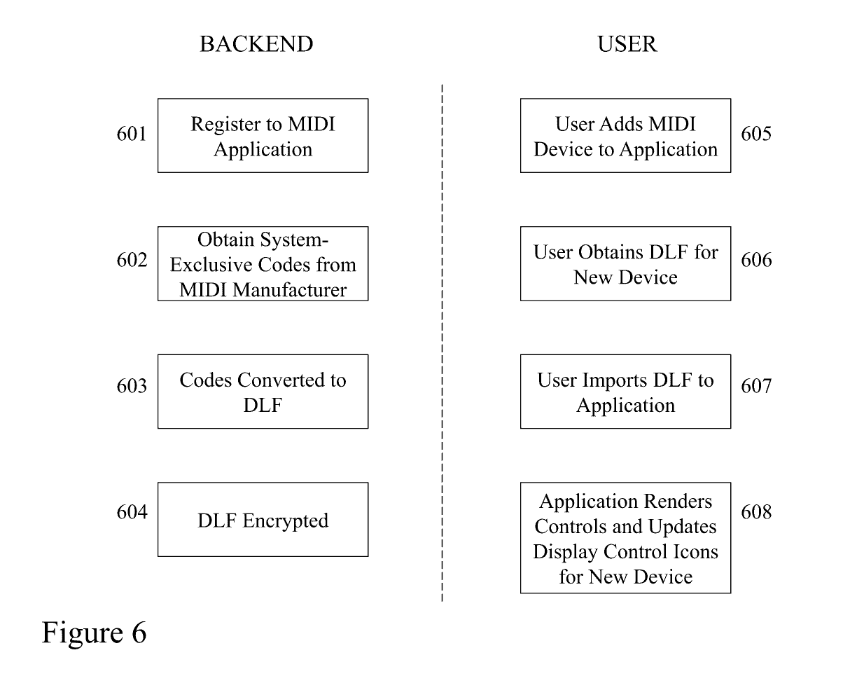

Now referring to FIG. 6 there is depicted a flowchart for the addition of a new MIDI device to an exemplary MIDI controller application according to an embodiment of the invention. From the MIDASP 100 backend processing administrators are able to register a new MIDI device to the MIDASP 100. After registration, the backend obtains the MIDI device manufacturer's system exclusive codes, either directly from the manufacturer in step 602 or from a central database/repository. The system exclusive codes are then converted to device library files (DLF) in step 603, and encrypted in memory in step 604. Once a MIDI device is registered on the MIDASP 100, a user couples their MIDI device to the MIDASP in step 605 thereby obtaining in step 606 and importing in step 607 (optionally requiring a payment) the MIDI device-specific DLF files into the MIDASP 100. With the DLF files for the newly-added MIDI device imported to the MIDASP 100, the MIDASP 100 updates the display and renders the necessary plurality of controls and control icons for said device in step 608 to the user.

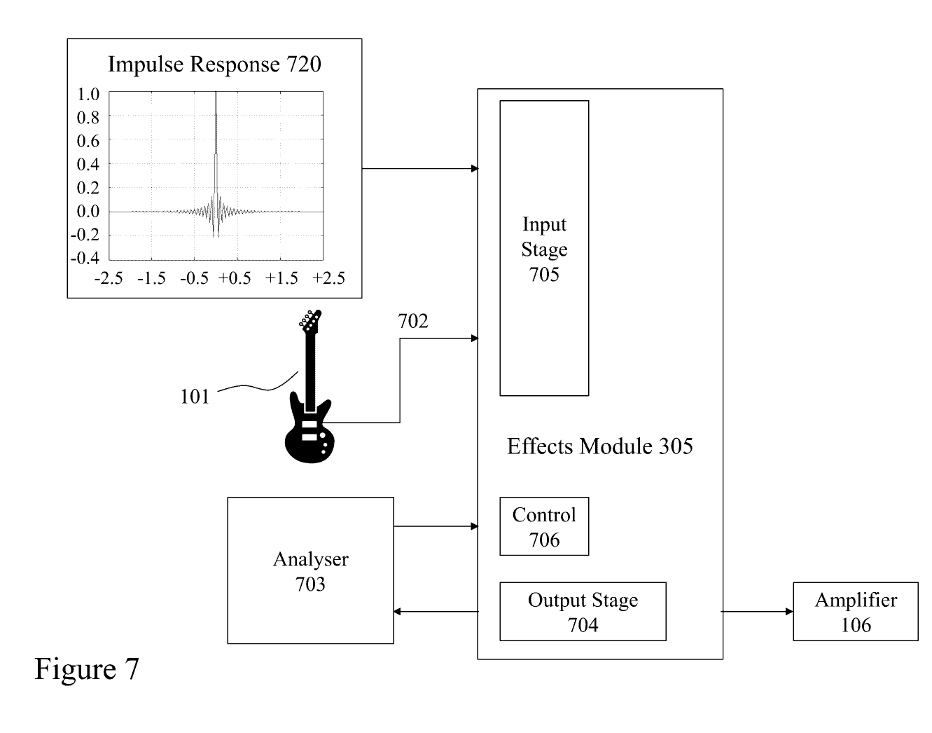

Referring to FIG. 7 there is depicted an example of a sound effect characterization module (SECM) 305 within an exemplary MIDI controller application, MIDASP 100, according to an embodiment of the invention. The SECM 305 is intended to operate to analyze a system capability and as closely as possible produce a required sound from an original sound based on the textual description which is input by the user. The SECM 305 implements the ability to characterize an input sound 702, from a MIDI instrument 101 for example, via an analyzer 703. The input sound 702 may be an original sound, modified sound, or resultant sound from any musical instrument, a sound-generating device, a sound-modifying device (not shown), a MIDI instrument 101, or MIDI device (not shown). The SECM 305 comprises a processor, memory and one or more algorithms. The SECM 305 processes the input sound 702 at the input stage 705 of the SECM 305, stores in memory the characterization of the input sound 702 which, in the case of a modified or resultant sound (via an amplifier 106) is the characterization of the combinatorial effects of the modifying devices. In this case, the patches used to create the input sound 702 are stored along with the characterized sound in the memory of the control 706 for output 704.

To begin characterization, all sound modifying devices are disabled. A sound modifying device is characterized by measuring and recording its frequency response curve. One sound modifying device is then enabled, and all parameters of said sound modifying device are swept while constraining the number of permutations such that each sample is sufficiently audibly different than the prior sample. For each increment, an impulse response 720 injected into the input stage 705 is recorded and stored in memory. For each applicable sound modifying device, an overall characterization of all recorded outputs is performed, using mathematical operations. Combined frequency response curves are determined through overall characterization of pair-wise combined sound modifying devices in either a series or parallel configuration.

The user can use pre-defined text-based definition of the characterization of a sound they are seeking (e.g. “crunch”, “soft”, etc.). In general, the text-based definition are terms known in the art relating to known sound characterization(s). The SECM 305 uses the stored characterization of the sounds, to recommend a patch that delivers the sound closest to the text-based definition.

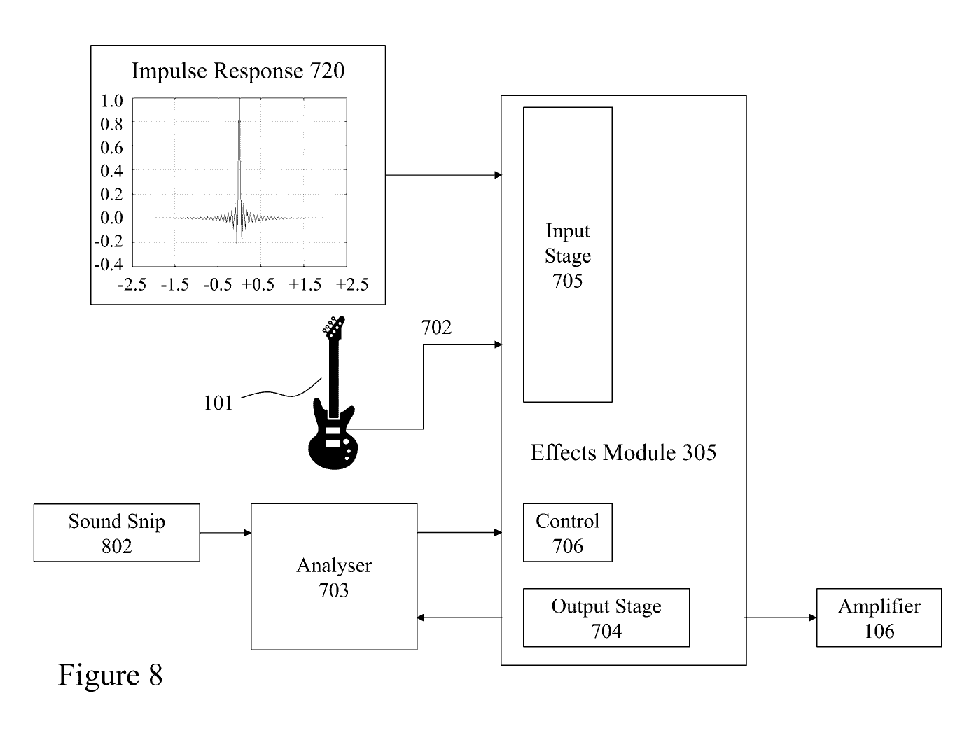

Now referring to FIG. 8 there is depicted an example of a sound effect characterization module using sound snips within an exemplary MIDI controller application, MIDASP 100, according to an embodiment of the invention. A user plays back a sound snip (snippet) 802 from an existing recording (e.g. a recording of a song by John Lennon) which is characterized by the analyzer 703 wherein the SECM 305 characterizes the sound produced by the recording and recommends a patch for each of one or more devices that delivers a sound closest to that within the sound snip.

Within another embodiment of the invention the GUI 220 of the MIDASP 100 is designed to be grid-based or grid-less, allowing the user to customize how the controls are placed on the screen, the size and shape of the controls etc. Optionally, the controls displayed on the interface by the MIDI application can be modified using voice-activated commands, or using gesture-based systems or using off-board hardware-based (physical) controls. The interface can optionally allow a user to modify two or more controls at the same time. Whilst the controls depicted in FIG. 2 are circular control it would be evident that other controller geometries such as linear vertical, linear horizontal etc. may be employed or that more complex controls may be provided such that a square allows concurrent adjustment of two controls (parameters). Multiple other control interfaces within the GUI 220 of the MIDASP 100 may be considered as are known within the art according to aesthetics, user preference, haptic interface characteristics etc.

Within another embodiment of the invention, two or more controls for one or more MIDI devices can optionally be configured to be linked together. As such, when moving one control, the other controls are changed at the same time. The change for the each of the other controls can be fixed or proportional to the change of the first control using a pre-determined proportion for each or all of the other controls and established, for example, through the user grouping the different controls together in a group within the GUI 220 or linking them through one or more commands and GUI actions. For example, each time a control on one MIDI device goes up by 1%, another control on the same MIDI device goes down by 10% and a control on a different MIDI device goes up by 0.5%. The link between the controls can be linear, non-linear or based on one or more pre-determined formulas or the MIDI device, MIDI instrument, a genre, a characteristic etc. Optionally, the controls are linked to a common group control and their relationship to the group control defines their adjustment rates/adjustment functions rather than any linking between the individual controls.

Within embodiments of the invention patches and/or combined patches may be generated and offered to users by a variety of enterprises, manufacturers, and third party providers. For example:
a provider of MIDI software, e.g. MIDASP 100, may include standard patches and/or combined patches just as with other software templates, stock images, etc. are provided with the initial software;
a provider of MIDI Device Applications may provide plug-ins for associating controls, patches, combined patches etc.;
users may provide links to patches, combined patches etc. within a SOCNET or SOME such that, for example, followers of a particular musician, group, etc. can access controls, patches, combined patches etc. for that musician, group etc.;
users may in addition to uploading or providing links to music, songs, audio, samples, sound-effects etc. for free use or purchase through online portals such as Beatport™ SoundCloud™, etc. may also offer controls, patches, combined patches etc. for download free or by purchase;
a commercial music retailer through their online portals, e.g. Apple™ iTunes™, HMV™, Google™ Music may also offer in specific sub-sections of their portals, or in association with the content users may purchase, the ability of users to access, test, download and purchase controls, patches, combined patches etc.

Optionally, controls, patches, combined patches etc. may be acquired by a user for trial or evaluation from a third party provider, enterprise, etc. wherein after a predetermined period of use rights to the controls, patches, combined patches etc. are rescinded unless the user purchases the controls, patches, combined patches etc.

It would be evident to one of skill in the art that controls, patches, combined patches etc. may be distributed, for example, with digital rights management features similar to those used in encrypting and protecting software, music, digital content etc.

Within embodiments of the invention a patch or combined patch may only function if all required MIDI devices are coupled to the electronic device. Within other embodiments of the invention a patch or combined patch may function if a predetermined subset of the required MIDI devices are coupled to the electronic device.

Accordingly, embodiments of the invention may include a MIDASP implemented as a system for controlling one or more MIDI devices and comprises a user-installed MIDI controller application on a computing device and the one or more MIDI devices for modifying or creating sound coupled to said application wherein the computing device comprises a processor, a memory, and an interface which allows coupling to the one or more MIDI devices via wired and or wireless means. The MIDASP system supporting the one or more MIDI devices having multiple MIDI controls programmed into said application wherein each MIDI control allows a user to manage and adjust the MIDI controls of each coupled MIDI device simultaneously via a digital display menu of controls and devices and the application saves in memory the settings of the controls on each coupled MIDI device that create a patch so that when said patch is recalled by the user via a menu selection the application modifies the controls of the one or more coupled MIDI devices to the requested settings as defined by the saved patch.

Accordingly, embodiments of the invention may include a MIDASP implemented as a cloud storage system and social media engine for the management and sharing of MIDI sounds whereby users may upload their MIDI sounds to a cloud database for sharing or selling to other users.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
providing an electronic device comprising at least a microprocessor and a haptic interface;
providing to the user a graphical user interface relating to a MIDI controller application;
establishing within the graphical user interface a plurality of controls, each control associated with a predetermined MIDI device of a plurality of MIDI devices; and
providing the user with options relating to the plurality of controls, wherein
a first option comprises:
establishing for each control within the plurality of controls a control setting via the haptic interface;
associating the plurality of controls and their control settings with a patch; and
storing the patch in association with an identity of the patch for subsequent retrieval and use within a memory;
a second option comprises:
associating a predetermined subset of the plurality of controls into a group via the haptic interface;
establishing for the group relationships between the predetermined subset of the plurality of controls and a group control via the haptic interface; wherein
adjusting the group control results in all of the predetermined subset of the plurality of controls associated with the group to which the group control relates being adjusted in dependence upon the adjustment made by the user to the group control and the relationship of each control of the predetermined subset of the plurality of controls to the group control; and
a third option comprises:
establishing for each control within the plurality of controls a control setting via the haptic interface;
controlling the plurality of MIDI devices in dependence upon the control settings of the plurality of controls.

2. The method according to claim 1, wherein
the electronic device comprises an interface which is at least one of a wired interface and a wireless interface; and
controlling the plurality of MIDI devices comprises transmitting data according to a predetermined standard to the plurality of MIDI devices via the interface.

3. The method according to claim 1, further comprising
a fourth option comprising:
retrieving from a memory a patch; and
controlling the plurality of MIDI devices by transmitting data according to a predetermined standard to the plurality of MIDI devices via one or more interfaces of the electronic device wherein the data relates to the plurality of controls and the control settings associated with each control of the plurality of controls.

4. The method according to claim 1, wherein
the electronic device is connected to each MIDI device of the plurality of MIDI devices via at least one of a wired connection, a wireless connection, and via messaging to an Internet Protocol address associated with a MIDI device.

5. The method according to claim 1, wherein
the GUI is either:
generated by a software application in execution upon the electronic device and stored within a memory of the electronic device; and
generated within a web browser interface by a software application in execution upon a remote server connected to the electronic device via a network.

6. The method according to claim 1, further comprising
a fifth option comprising:
establishing for each control within the plurality of controls a control setting via the haptic interface;
associating the plurality of controls and their control settings with a patch via the haptic interface; and
storing the patch in association with an identity of the patch upon within a memory of a remote server coupled to the electronic device via a network.

7. The method according to claim 1, further comprising
a sixth option comprising:
receiving from a user a request for a patch;
retrieving from a memory the patch which comprises a plurality of controls and a control setting for each control within the plurality of controls, the memory associated with at least one of another user's electronic device, a third party website, an enterprise website, a MIDI device, and a MIDI instrument.

8. Computer executable instructions stored within a non-volatile non-transitory memory, the instructions when executed relating to a process comprising:
providing to a user upon an electronic device comprising at least the microprocessor and a haptic interface a graphical user interface relating to a MIDI controller application;
establishing within the graphical user interface a plurality of controls, each control associated with a predetermined MIDI device of a plurality of MIDI devices; and
providing the user with options relating to the plurality of controls, wherein
a first option comprises:
establishing for each control within the plurality of controls a control setting via the haptic interface;
associating the plurality of controls and their control settings with a patch; and
storing the patch in association with an identity of the patch for subsequent retrieval and use within a memory;
a second option comprises:
associating a predetermined subset of the plurality of controls into a group via the haptic interface;
establishing for the group relationships between the predetermined subset of the plurality of controls and a group control via the haptic interface; wherein
adjusting the group control results in all of the predetermined subset of the plurality of controls associated with the group to which the group control relates being adjusted in dependence upon the adjustment made by the user to the group control and the relationship of each control of the predetermined subset of the plurality of controls to the group control; and
a third option comprises:
establishing for each control within the plurality of controls a control setting via the haptic interface;
controlling the plurality of MIDI devices in dependence upon the control settings of the plurality of controls.

9. The computer executable instructions according to claim 8, wherein
the electronic device comprises an interface which is at least one of a wired interface and a wireless interface; and
controlling the plurality of MIDI devices comprises transmitting data according to a predetermined standard to the plurality of MIDI devices via the interface.

10. The computer executable instructions according to claim 8, further comprising
a fourth option comprising:
retrieving from a memory a patch; and
controlling the plurality of MIDI devices by transmitting data according to a predetermined standard to the plurality of MIDI devices via one or more interfaces of the electronic device wherein the data relates to the plurality of controls and the control settings associated with each control of the plurality of controls.

11. The computer executable instructions according to claim 8, wherein
the electronic device is connected to each MIDI device of the plurality of MIDI devices via at least one of a wired connection, a wireless connection, and via messaging to an Internet Protocol address associated with a MIDI device.

12. The computer executable instructions according to claim 8, wherein
the GUI is either:
generated by a software application in execution upon the electronic device and stored within a memory of the electronic device; and
generated within a web browser interface by a software application in execution upon a remote server connected to the electronic device via a network.

13. The computer executable instructions according to claim 8, further comprising
a fifth option comprising:
establishing for each control within the plurality of controls a control setting;
associating the plurality of controls and their control settings with a patch; and
storing the patch in association with an identity of the patch upon within a memory of a remote server coupled to the electronic device via a network.

14. The computer executable instructions according to claim 8, further comprising
a sixth option comprising:
receiving from a user a request for a patch;
retrieving from a memory the patch which comprises a plurality of controls and a control setting for each control within the plurality of controls, the memory associated with at least one of another user's electronic device, a third party website, an enterprise website, a MIDI device, and a MIDI instrument.

15. A method comprising:
providing to a user via a graphical user interface on an electronic device access to an online portal;
providing to the user within the graphical user interface with options relating to a patch associated with a software application controlling a plurality of MIDI devices;
determining an action in dependence upon the option selected by the user.

16. The method according to claim 15, wherein
the option relates to at least one of storing and uploading a patch; and
the action relates to uploading the user generated path to a remote storage system via a network coupled to the electronic device.

17. The method according to claim 15, wherein
the option relates to posting at least one of a patch and item of audio content to a social network; and
the action comprises uploading the at least one of the patch and the item of audio content to the social network allowing other users of the social network to at least one of download and purchase the at least one of the patch and the item of audio content.

18. The method according to claim 15, wherein
the patch is generated by a process comprising:
establishing within a graphical user interface a plurality of controls, each control associated with a predetermined MIDI device of a plurality of MIDI devices;
establishing for each control within the plurality of controls a control setting via the haptic interface;
associating the plurality of controls and their control settings with the patch; and
storing the patch in association with an identity of the patch within a memory.
